(19) United States
(12) Patent Application Publication
(10) Pub. No.: US 2019/0217798 A1
(43) Pub. Date: Jul. 18, 2019

(54) AUTOMOBILE UNDERSIDE PROTECTOR

(71) Applicant: SLIPLO, Inc., Sherman Oaks, CA (US)

(72) Inventor: Andishe Soleimanpour, Sherman Oaks, CA (US)

(21) Appl. No.: 15/873,145

(22) Filed: Jan. 17, 2018

(51) Int. Cl. B60R 19/44; C09J 7/25

(52) U.S. Cl. CPC B60R 19/445; C09J 2201/128; C09J 2475/006; C09J 7/25

(57) ABSTRACT

An automobile underside protector includes a flexible elongated band formed of a material with a hardness in a range from 70 Shore A to 95 Shore A. The band has a front edge and a back edge each with a height in a range from 0.12 to 0.4 inches, and a top surface and a bottom surface. A juncture of the front edge and the bottom surface has a rounded bevel, and a juncture of the back edge and the bottom surface has a rounded bevel. The back edge has notches to form teeth such that a width of the band from the front edge to an apex of each notch is in a range from 0.15 to 0.5 inches. An adhesive is applied on the top surface of the band.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND

### Field

The disclosure relates to a device for protecting automobiles from impact, and more particularly, to a device for protecting the underside of automobiles from damage.

### Description of the Related Art

Automobile drivers often encounter situations where the underside of the automobile, scrapes against a steep driveway, a speed bump, a parking block, or an uneven road surface, which can damage the automobile's bumper or rocker panels. This type of damage can be expensive to repair.

Many existing forms of automobile underside protection are custom made for specific automobiles, which can make them expensive and challenging to install. There is a need for durable and easy to install under bumper protection that can be applied to different types of automobiles.

### DESCRIPTION OF THE DRAWINGS

FIG. 1A is a schematic side view of an automobile underside impacting a roadway.

FIG. 1B is a schematic side view of an automobile underside impacting a parking block.

FIG. 2A is a schematic bottom view of an automobile underside protector.

FIG. 2B is a side view of the automobile underside protector of FIG. 2A.

FIG. 3A is a schematic perspective view showing radial bending of an automobile underside protector.

FIG. 3B is a schematic perspective view showing lateral bending of an automobile underside protector.

FIG. 4 is an enlarged schematic front view of an automobile underside protector installed on an automobile.

FIG. 5A is a schematic bottom perspective view showing application of automobile underside protectors on an automobile.

FIG. 5B is a schematic bottom view showing a configuration of automobile underside protectors.

FIG. 6 is a schematic bottom view showing automobile underside protectors installed on an automobile.

### DETAILED DESCRIPTION OF THE INVENTION

A device for protecting an underside of an automobile is described herein. Throughout this description, the embodiments and examples shown should be considered as exemplars, rather than limitations on the apparatus described.

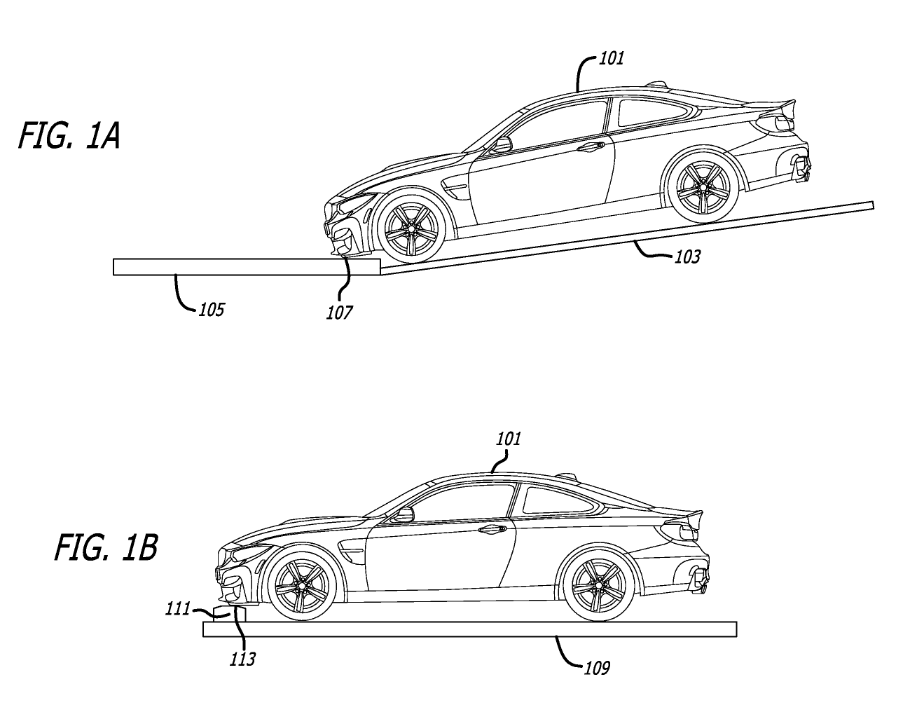

As shown in FIG. 1A, an underside of an automobile 101 can be damaged when a driveway 103 intersects a roadway 105 at a steep angle, rather than being level with each other. Because of the steep angle, the underside of the automobile 101 scrapes against the roadway 105 at a point of impact 107 (e.g., an underside of the bumper), causing damage to the automobile 101, such as scratched paint, scuff marks, or even holes or dents. As shown in FIG. 1B, similar damage can occur when the automobile 101 is being parked in a parking lot 109 and the automobile 101 scrapes against a parking block 111 at a point of impact 113.

An automobile underside protector, as disclosed herein, can prevent or reduce damage to an underside of an automobile. The protector can be positioned on the underside of an automobile where the automobile is most likely to impact objects that will cause damage. For example, the protector can be positioned at a front edge of an underside of the bumper. If the automobile does impact an object, such as a parking block or an uneven roadway, the protector will be impacted instead of the automobile, so that the automobile is not damaged.

The automobile underside protector can be formed of a semi-hard, yet flexible and resilient, abrasion resistant, high tear strength material. The protector can be shaped so that it can be easily formed to the underside of various different automobiles. Further, the protector can be easily applied via an adhesive on the side of the protector adjacent the automobile. The protector can have rounded or beveled edges to minimize grabbing onto the object of impact.

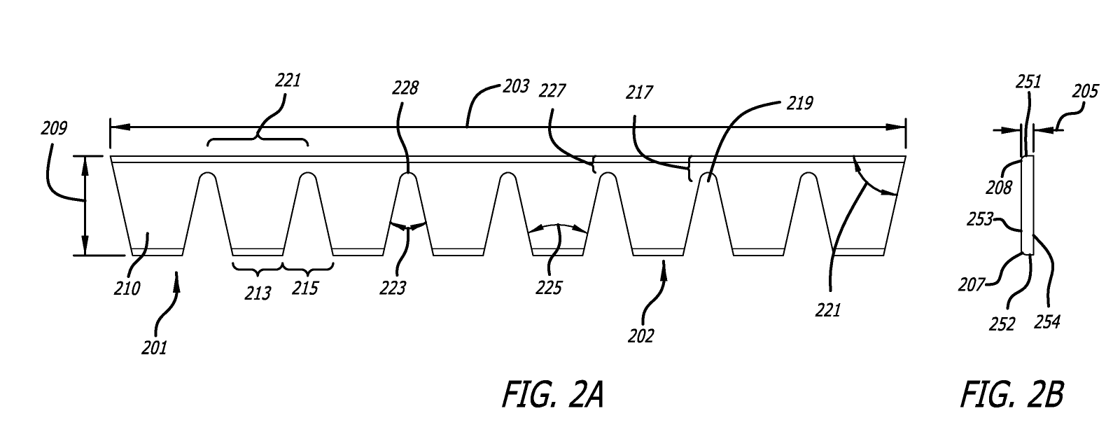

In one example, an automobile underside protector 201 for application to an underside of an automobile is shown in FIGS. 2A and 2B. The protector 201 can be applied to a bottom or underside surface of the automobile's bumper to protect the bumper from damage if the automobile scrapes against a roadway, parking block, road debris, or any other object.

The protector 201 can be a flexible elongated band 202 formed of any suitably hard or semi-hard material, such as polyurethane or other types of flexible rubber or plastic. A suitable hardness of the material is necessary so the protector 201 is hard enough to have sufficient tear strength and abrasion resistance, but not too hard for the protector to be bent to form to the automobile during application of the protector 201.

This optimization is a balance between the amount of material found between the protector's edge and a root of the notch in the protector to facilitate bending during installation. A greater amount of material is desired to provide protection and abrasion resistance during contact between the protector and the road. However, a depth of the notch must be deep enough to facilitate bending during installation on curved surfaces on the underside of an automobile bumper. Optimizing an amount of material present versus an amount removed by the notch is desirable.

Numerous sample protectors were tested to determine a force required to bend the protector 15 degrees and 30 degrees. Those forces were studied for significant points of inflection in the data. From the data set, it can be seen where the inflection point is most noticed. In one test, a protector with a height of 3/16 inch and a width of 1.5 inches was tested with notches of different depths. A force required to bend the protector 15 degrees and 30 degrees significantly increased when a distance between a front edge of the protector and an apex of the notch was greater than about 0.25 inches. In another test, a protector with a height of ¼ inch and a width of 1.5 inches was tested with notches of different depths. Again, a force required to bend the protector 15 degrees and 30 degrees was significantly increased when a distance between a front edge of the protector and an apex of the notch was greater than about 0.25 inches.

Additionally, qualitative analysis was performed to determine a desirable amount of force to bend the protector during installation, as well as protection provided when an installed protector contacted an asphalt driveway. From this testing, and the desire to have the most amount of material present in the protector as possible, it has been determined that a desirable depth from the front edge to an apex of the notch is 0.25 inches. Protectors with depths greater about 0.4 inches were difficult to install and tended become detached from the automobile. Protectors with depths less than 0.15 inches provided insufficient protection from scrapes and scratches.

An exemplary suitable hardness range is from 70 Shore A to 95 Shore A, and an exemplary optimum hardness is 85 Shore A. In one example, the protector 201 can be formed of Versathane® A-8, TDI-Polyester Prepolymer, manufactured by Coim USA Inc. The protector 201 can be made using a profile extrusion method or other comparable manufacturing methods such as compression molding or mold casting. Protectors formed from materials with a hardness less than 70 Shore A provided insufficient protection, and protectors formed from materials with a hardness greater than 95 Shore A were difficult to bend to install.

In an example, the protector can be formed of a material with an abrasion loss with in a range of 25 mm³ to 50 mm³ based on ISO 4649, and with a tear strength in a range of 40 kN/m to 85 kN/m based on DIN ISO 34-1/B/b.

The protector 201 has a front edge 251, a back edge 252, a bottom surface 253, and a top surface 254. The protector 201 can be formed to have any suitable length 203, such as a length from 6 inches to 48 inches. Exemplary protectors 201 can have a height 205 of between about 0.12 and 0.4 inches. In one example, the protector 205 can have a height 205 of about 0.23 inches. Both a bevel 208 between the front edge 251 and the bottom surface 253 and a bevel 207 between the back edge 252 and the bottom surface 253 can have a radius of curvature of about 3/32 inch. The protector can have a width 209 of in a range from about 1.00 inches to 2.00 inches. For example, the protector can have a width of about 1.5 inches.

Notches can be cut in the back edge 252 of the protector 201 to form teeth 210. For example, the protector 201 can be put through a mandrel punch press to have the notches punched out. Other notch manufacturing techniques may also be used, such as die cutting, water jetting, laser cutting or the like. The notches can be u-shaped, v-shaped, s-shaped, or hexagonally-shaped. A u-shaped notch, i.e., a notch with a u-shaped apex, is shown in FIG. 2A. The u-shaped notch has a radius 219 of about 0.12 inches at a distance 217 of about 0.41 inches from the front edge 251. Because of the increased flexibility of the protector 201 due to the notches, the protector 201 can be formed to fit the shape of most automobiles without the need for additional hardware. The notches allow for the protector 201 to be flexed in three-dimensions.

As shown in FIG. 2A, adjacent teeth 210 can have edges at an angle 223 of about 30 degrees to each other, and the edges of an individual tooth 210 can have an angle 225 of about 30 degrees to each other. An angle 221 between the inside edge of the tooth and the front edge 251 can be about 75 degrees. A length 211 of the tooth 210 towards the front edge 251 can be about 1.5 inches, and a length 213 of the tooth 210 at the back edge 252 can be about 0.65 inches. A space 215 between teeth at the back edge 252 can be about 0.9 inches.

A width 227 of the protector 201 between the apex 228 of the notch and the front edge 251 can have a range from about 0.15 to 0.5 inches. In one example, the width 227 can be about 0.25 inches. Width 227 should be wide enough to provide sufficient protection for the automobile, but not so wide that the protector 201 is difficult to bend during installation. For example, this optimization is a balance between the amount of material found between the front edge 251 and the apex 228 of the notch to facilitate bending of the protector 201 during installation. A sufficient amount of material is desired to provide the greatest protection for the automobile and abrasion resistance during contact between the protector and an object. However, the depth of the notch is adequately or sufficiently deep to facilitate bending during installation on the curved underside of automobiles.

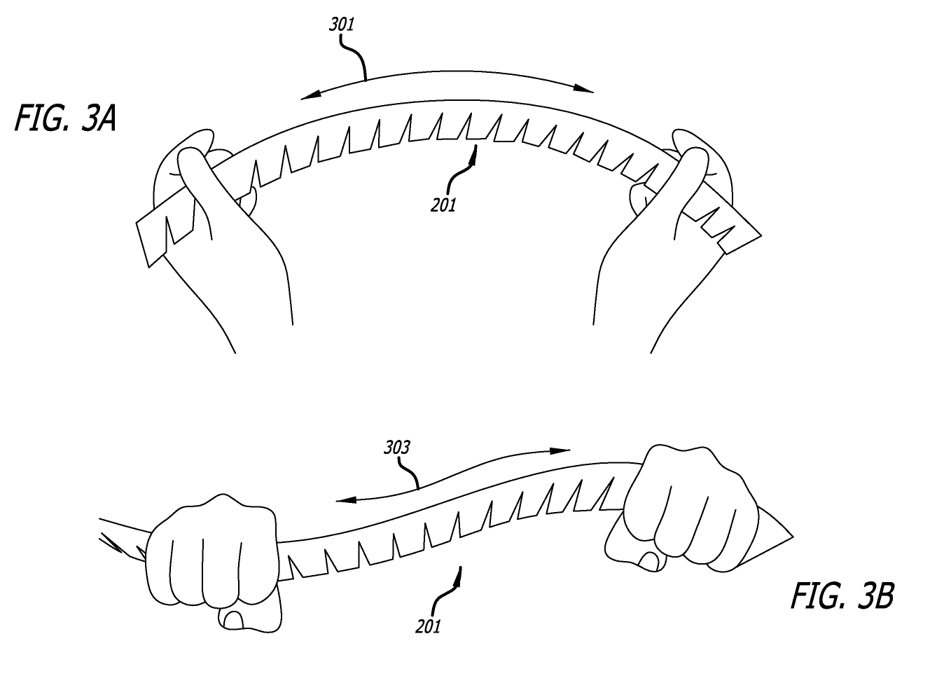

As shown in FIG. 3A, because of the notches, the protector 201 can be bent radially 301. For example, the protector can be curved about an axis parallel to, and outside the plane of, the top and bottom surfaces. As shown in FIG. 3B, the protector 201 can also be bent or flexed laterally 303. For example, the protector 201 can be curved about an axis normal to the plane of the surfaces. The protector 201 can be both radially and laterally bent at the same time to achieve a multitude of shapes to accommodate application to different types of automobiles with various dimensions and curvatures.

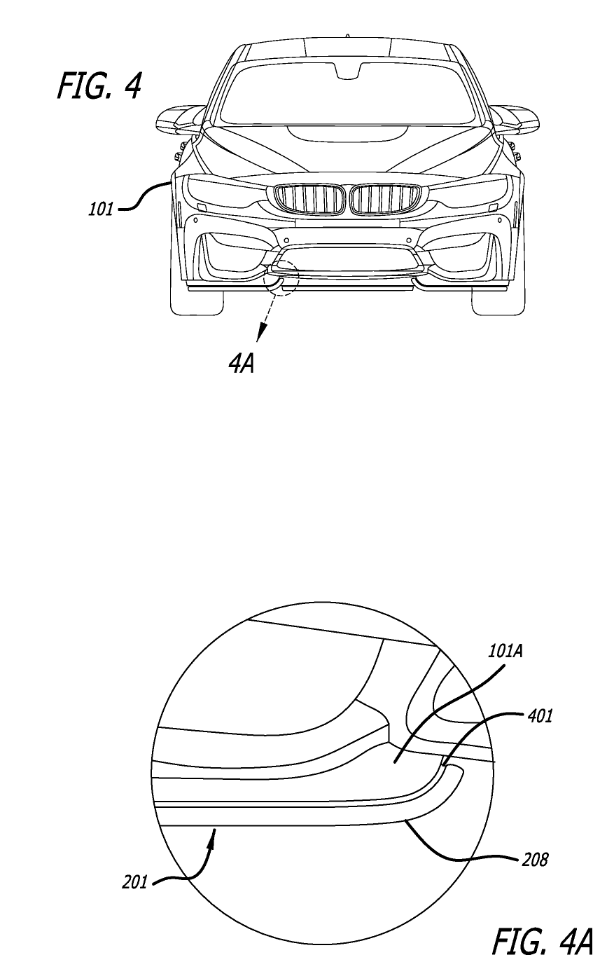

The protector 201 can be installed on a bottom surface of a bumper 101A of automobile 101, as shown in FIG. 4. The band of semi-hard material 202, as described above, can be attached to the bumper 101A via an adhesive 401 attached to the top side 254. The adhesive 401 can be a double-sided tape adhesive, such as a double-coated acrylic foam tape designed for attachment of automotive exterior trim parts. The adhesive 401 can have a thickness between about 0.75 mm and 1.55 mm. A removable liner (not shown) may be applied to an exposed side of the adhesive to protect the adhesive before the protector 201 is installed. An example of an adhesive 401 is Acrylic Plus Tape Series EX4000 manufactured by 3M™. The 3M EX4000 tape is suitable for this application due to quick bonding time in cold weather and excellent resistance to impact in cold weather. Further, the foam core provides stress relaxation when high application loads are encountered, and the tape has high adhesion performance to low energy surfaces such as urethane and scratch-resistant and mar-resistant automotive paint systems.

In one example, a bond between the adhesive and the semi-hard protective material can be improved via a Corona treatment process to increase positive surface energy of the urethane material and allow for a stronger bond. Corona treatment, or air plasma, is a surface modification technique that uses a low temperature corona discharge plasma to change properties of a surface. In other examples, the bond between the adhesive can be improved via a flame etching treatment or a plasma treatment. After the semi-hard protective material has undergone the treatment process, the adhesive can be bonded to the corona treated surface.

In one example, the notches are formed in the protector 201 after the adhesive has been applied.

To apply the protector 201 to the automobile, the liner is removed, and the protector is firmly pressed against the underside of the automobile in the desired position. It can be desirable to start application of the protector from one end and press one portion at a time into position while progressing to the other end. The automobile surface can be prepared by cleaning with a mixture of 70% isopropyl alcohol (IPA) and 30% water to ensure that the surface is free of contaminants. Surfaces with existing scratches can be lightly abraded using a sand paper in order to smooth the textured surface to obtain more flatness, allowing improved contact area and adhesion. Further, priming a surface using a 3M Tape Primer 94 can improve initial and long-term adhesion to both new and scratched surfaces.

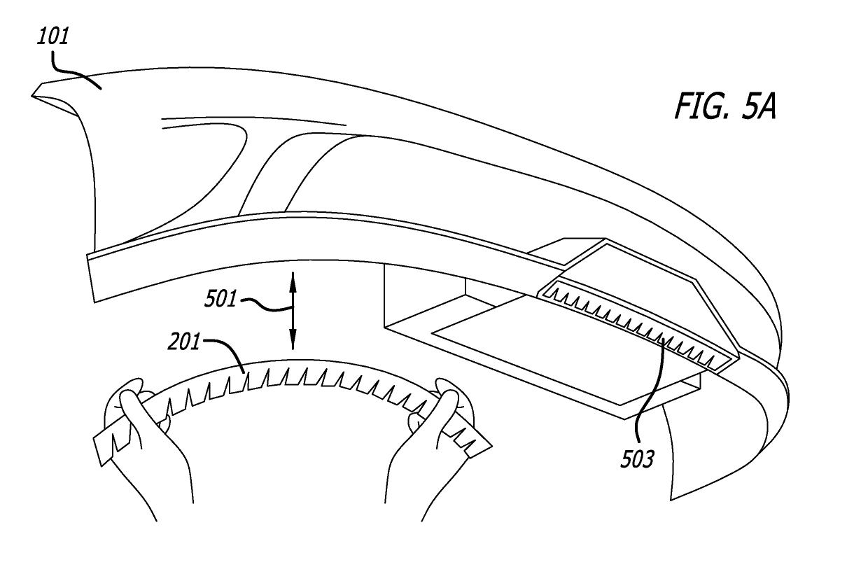

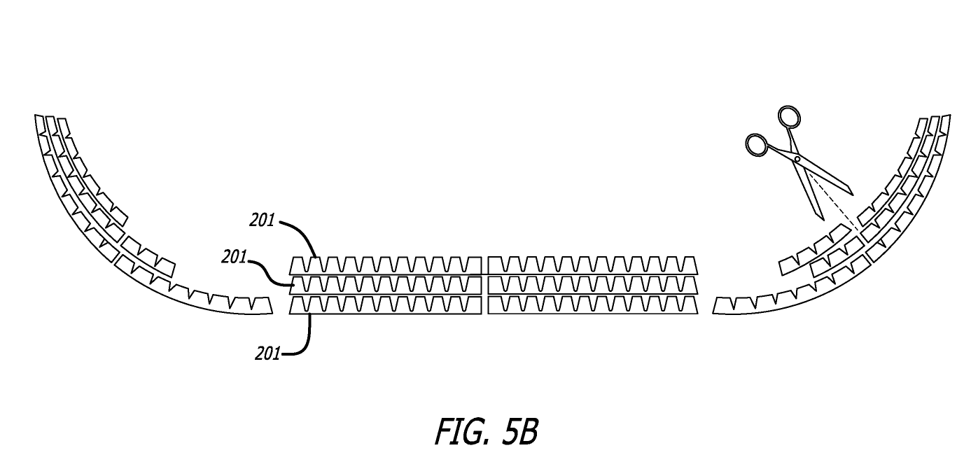

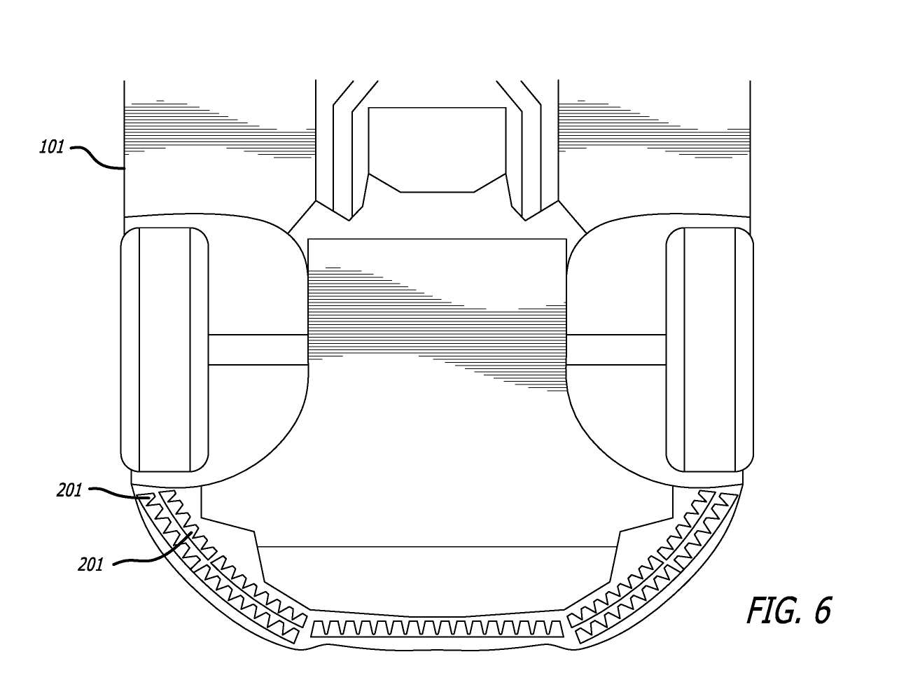

The protector 201 can be bent to be applied 501 to curved portions of the underside of the automobile 101 or can be left straight to be applied 503 to straight portions of the underside of the automobile 101, as shown in FIG. 5A. Multiple protectors 201 can be applied in adjacent rows to provide protection to larger surfaces, and protectors 201 can be cut to fit, as shown in FIG. 5B. FIG. 6 shows a bottom view of an automobile 101 where multiple protectors 201 have been shaped and cut to provide protection to the bottom surface of the bumper.

The protector can be any of one or more desired colors, such as black, white, or any color that matches a color of the automobile. The protector can also be clear or transparent. The protector can also be colors chosen as an accent or to be easily noticed by observers, such as bright or fluorescent colors. Characters, designs, or logos can also be included on any portion of the protector.

The surfaces of the protector, e.g., the front and back edges and top and bottom surfaces, can have various different textures. For example, the front edge and bottom surface can be smooth to reduce grabbing of the protector by an impacted object. The top surface can have a texture that will facilitate adherence of the adhesive.

The protector can have additional layers, such as a protective coating or metal guards. The material of the protector can have inclusions, e.g., inclusions that have a different hardness from the primary material of the protector.

While the protector is described and shown as having a rectangular cross-section, the protector can have cross-sections of other shapes, such as wedge-shapes. For example, the front edge can be taller or shorter than the back edge, or the top surface can be wider or narrower than the back surface. Further, the front edge can be at an angle of less than 90 degrees to the top surface, so that the protector is less likely grab an impacted objected.

The adhesive can be either a dark or black color, or a color that matches the automobile. The adhesive can also be a brighter color chosen as an accent color. The adhesive can also be clear or transparent.

Though the protector is generally installed with the front edge towards the front, it can be installed in various other configurations to fit the underside of the automobile. In addition to the bumper, the protector can be installed on any desired portion of the automobile, such as under side portions of the automobile, under rocker panels, under a rear bumper, etc.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention claimed.

1. An automobile underside protector comprising:
a flexible elongated band formed of a material with a hardness in a range from 70 Shore A to 95 Shore A, the band having a front edge and a back edge each with a height in a range from 0.12 to 0.4 inches, and a top surface and a bottom surface, wherein a juncture of the front edge and the bottom surface has a rounded bevel, wherein a juncture of the back edge and the bottom surface has a rounded bevel, and wherein the back edge has notches to form teeth such that a width of the band from the front edge to an apex of each notch is in a range from 0.16 to 0.5 inches, and an adhesive applied on the top surface of the band; and wherein the protector has an abrasion loss with in a range of 25 mm\hat{ }3 to 50 mm\hat{ }3 based on ISO 4649.

2. The automobile underside protector of claim 1, wherein the band is formed of polyurethane.

3. The automobile underside protector of claim 1, wherein a width of the teeth is greater than the width of the band from the front edge to the apex of the notch.

4. The automobile underside protector of claim 1, wherein the adhesive comprises double-sided tape adhesive.

5. The automobile underside protector of claim 1, wherein the top surface is corona treated prior to application of the adhesive.

6. The automobile underside protector of claim 1, wherein each of the rounded bevels has a radius of 3/32 inch.

7. The automobile underside protector of claim 1, wherein a width of the band is in a range from 1.00 inches to 2.00 inches.

8. The automobile underside protector of claim 1, wherein the apex is rounded.

9. The automobile underside protector of claim 1, wherein the apex has a radius in a range from 0.12 inches to 0.40 inches.

10. The automobile underside protector of claim 1, wherein edges of adjacent notches are at an angle to each other in a range from 20 degrees to 40 degrees range.

11. The automobile underside protector of claim 1, wherein the band has a hardness of 85 Shore A.

12. An automobile underside protector comprising:
a flexible elongated band formed of a material with a hardness in a range from 70 Shore A to 95 Shore A, the band having a front edge, a back edge, a top surface, and a bottom surface, wherein a juncture of the front edge and the bottom surface has a rounded bevel, and wherein the back edge is notched to form teeth, and an adhesive on the top surface of the band; and wherein the protector has an abrasion loss with in a range of 25 mm\hat{ }3 to 50 mm\hat{ }3 based on ISO 4649.

13. The automobile underside protector of claim 12, wherein a width of the teeth is greater than a width of the band from the front edge to an apex of the notch.

14. The automobile underside protector of claim 12, wherein the rounded bevel has a radius of 3/32 inch.

15. The automobile underside protector of claim 12, wherein a width of the band is in a range from 1.00 inches to 2.00 inches.

16. The automobile underside protector of claim 12, wherein an apex of each of the notches is rounded.

17. The automobile underside protector of claim 12, wherein edges of adjacent notches are at 30 degrees to each other.

18. The automobile underside protector of claim 12, wherein the band has a hardness of 85 Shore A.

19. The automobile underside protector of claim 12, wherein the front edge and the back edge each have a height in a range from 0.12 and 0.4 inches.

20. The automobile underside protector of claim 12, wherein a width of the band from the front edge to an apex of each notch is in a range from 0.15 to 0.5 inches.
